(19) United States
(12) Patent Application Publication
(10) Pub. No.: US 2015/0158326 A1
(43) Pub. Date: Jun. 11, 2015

(54) Material Panel Having a Graphic Surface Structure

(71) Applicant: Hueck Rheinische GmbH, Viersen (DE)

(72) Inventor: Oliver Espe, Bochum (DE)

(21) Appl. No.: 14/615,448

(22) Filed: Feb. 6, 2015

Related U.S. Application Data
(62) Division of application No. 13/640,315, filed on Oct. 10, 2012.

(30) Foreign Application Priority Data
May 19, 2010 (DE) 20 2010 006 959.9

(51) Int. Cl. B44C 1/10

(52) U.S. Cl. CPC B44C 1/10

(57) ABSTRACT

The particular advantage of the present invention is that a decorative layer is precisely matched to a surface structure. This enables very realistic wood patterns and other natural and artificial patterns to be produced. In addition, the edge contours of the individual areas in the structure and decoration can have an irregular form, but it is equally possible to additionally provide the individual areas with a separate structure that, for example, points in different directions. Thus, a strictly graphic motif can be created that is suitable for the manufacture of furniture as well as for the manufacture of door elements or panels, for either floors or walls.

### CROSS REFERENCE TO RELATED APPLICATIONS

This application is a divisional application of U.S. Ser. No. 13/640,315, filed on Oct. 10, 2012, which was the U.S. national stage of International Application No. PCT/DE2011/001689, filed on May 17, 2011, and it claims the benefit thereof. The international application claims the benefit of German Application No. DE202010006959.9 filed on May 19, 2010; all applications are incorporated by reference herein in their entirety.

### BACKGROUND

1. Field of Use of the Invention

The invention relates to a material plate, in particular for the manufacture of furniture, floor coverings or door elements, comprising at least one central substrate layer and one decorative layer on at least one side of the substrate layer.

2. Prior Art

Material plates of the generic type are mainly used for the manufacture of furniture, door elements or floor panels. Here, for the manufacture of the material plates, a fibrous material is used which is covered with several layers at least on one side, preferably on both sides, to be bonded in a press by melting on a hot-melt adhesive. For this reason, the layers are impregnated with an amino resin, for example melamine formaldehyde resin, so that the amino resin layer can cure during pressing under the simultaneous action of heat, and a bond of the individual layers with the substrate layer is created. The layers used here consist at least of one decorative layer and one overlay. The decorative layer can consist of the imitation of a natural wood or stone surface.

Material plates produced in this manner are preferably employed for the manufacture of furniture. It is equally possible to produce door leaves or panels for floors or walls. Preferably, patterns are used here which include a wood grain, where it is important to imitate the latter as faithfully as possible both in view of the printed design (decorative layer) and the required embossment. For this reason, pressing plates are used that include a reversed printing of the material plates to be pressed. Thus, the structure of the pressing plate can be transferred to the upper cover layer of the substrate layer in the pressing procedure. For this, normally large pressing plates having a format of 2.3×6 m are used to produce large-sized material plates which can be subsequently cut for the respective intended purpose in the furniture industry. The same applies to panels and door leaves.

### SUMMARY

The particular advantage of the present invention consists in that arbitrary geometric designs can be produced to perform surface structuring. This can be done, for example, by only having an edge contour of the individual areas in an irregular form, but it is equally possible to additionally provide the individual areas with a separate structure which, for example, points into different directions. Thus, a strictly graphic motif is created which is suited for the manufacture of furniture as well as for the manufacture of door elements or panels, no matter whether for floors or for walls.

### DETAILED DESCRIPTION

To meet individual customer demands and realize new patterns, it is an object of the present invention to provide a material plate and a pressing plate that permit multifarious designs.

To achieve the object, it is provided for the decorative layer to comprise adjacent adjoining areas which at least partially comprise a grain of the decoration and/or structure in different directions. Further advantageous embodiments of the invention can be taken from the subclaims.

In contrast to the former tendency of providing door leaves, furniture doors or fronts with a uniformly extending decoration, which essentially consists of a wood grain and has an accurately-fitting embossment, one is giving up on this former procedure and chooses a decorative layer which comprises adjacent adjoining areas, the areas at least partially comprising a grain of the decoration and/or structure in different directions. The material plate is thus subdivided into a plurality of adjacent areas which differ from the conventional patterns in that strictly graphic patterns are formed which in turn comprise a grain of the decoration and/or structure that extends in different directions. Thus, attractive patterns are achieved which can be employed in the furniture industry in an attractive and future-oriented way. The individual areas can comprise an accurately-fitting embossment in view both of the grain of the decoration and the grain of the structure. An accurately-fitting embossment is defined as a particular embossment in which the pattern of the decorative layer is in concordance with the embossed structure of the pressing plate. Thus, for example, wood pores can be particularly emphasized by corresponding deep embossing, so that an observer will get the impression that it is naturally grown wood, wherein the existing embossment furthermore creates a surface feel which will give the impression of a natural wood material when it is touched. The use of a wood decor is here only mentioned by way of example, it can equally be the structure of a granite surface or other natural materials.

By the formation and different structuring of adjacent adjoining areas, a surface design is achieved here which opens up new multifarious scopes for design to produce surfaces of furniture, door elements or floor panels.

A further aspect of the invention provides that the areas of the decorative layer can have an irregular edge contour, in particular following polygonal lines, wherein adjacent areas can at least partially have a common edge contour. Thus, the individual areas are strictly defined with respect to each other and can at least partially have a common edge contour. It is decisive that the areas themselves can be arbitrarily varied as to their sizes and designs and that it is thus possible to represent an irregular edge contour, for example, as following polygonal lines. As an alternative, it is possible that the areas consist of simple geometric shapes, in particular of circles, triangles, polygons or rectangles, with an at least partially straight edge contour. With this design, too, adjacent areas have a partially common edge contour or can additionally penetrate each other.

Penetrating in this case means that individual shapes, for example a triangle, projects with a tip into another area. It is thus possible to shape the areas such that they either only have an irregular edge contour or are combined with strictly geometric shapes. For example, a section of the edge contour could be strictly straight-lined, and a further section could be curved, where the number of different areas can be arbitrarily combined with each other, so that individual areas are joined, as in a jigsaw.

For the manufacture of the material plate, here a decorative layer is used which consists at least of a decorative paper and an embossment on one side of the material plate. To this end, presses are used which can perform an embossment both on the face and optionally also on the reverse of the material plate, wherein the employed pressing plates are preferably provided with an accurately-fitting reversed structure of the surface to be produced. By the concordance of the pressing plate structure with the decorative paper, in the present case, the impression of an inlaid work with corresponding raised and lower regions is achieved in the individual areas.

Depending on the intended purpose, the material plates can here be provided with a decorative layer and an embossment on one side or optionally on either side. To bond the individual layers to the substrate layer, it is provided here that at least on one side, preferably on either side, a layer of glue is disposed between the substrate layer and the decorative layer.

To be able to emboss particularly deep structures, one or several underlays are preferably inserted between the substrate layer and the decorative layer, which can consist, for example, of kraft paper impregnated with resin, or glass mat woven impregnated with resin. Such an arrangement is selected at least for one side of the material plate, optionally on both sides. It is thus possible to emboss particularly deep structures without the substrate layer also having to be embossed.

To achieve surfaces of particularly high-quality which are also resistant to conventional cleansing agents, it is furthermore provided that at least on one side of the material plate, a layer sequence of overlay and decorative layer is provided. With the aid of the overlay, which is usually transparent, the sensitive decorative layer is finally protected, wherein the overlay can also be impregnated with a layer of glue, that means with an amino resin, so that a permanent bond between the overlay, the decorative layer and the substrate layer can be produced.

If high abrasion resistance of the produced surfaces of the material plates is desired, the decorative layers and/or overlays can be furthermore enriched with abrasion-resistant particles. As abrasion-resistant particles, corundum can be essentially considered, however, already cured melamine or glass can be also introduced into one of the upper layers to thus design the layer to be abrasion-resistant and more stable against wear.

As the substrate layer, fibrous materials or materials containing chips can be basically used, such as MDF, HDF, chip, OSB or plywood. Here, the desired quality and strength of the material plate is important to be able to employ the latter, for example, as material plate for the furniture industry or the like.

It is furthermore an object underlying the invention to provide a novel pressing plate which is suited for the manufacture of material plates with different areas.

The technical problem is solved by the pressing plate comprising a surface structure which comprises adjacent adjoining areas which at least partially comprise a grain of the decoration and/or the structure in different directions.

To design the embossment of the material plates as simple as possible and for example permit an accurately-fitting embossment of the material plates, a pressing plate is suggested which has a corresponding reversed structure in the desired shape with the creation of different areas. The individual areas here at least partially comprise a grain of the decoration and/or structure in different directions, so that strictly graphic patterns are formed.

In the aspect of the invention, it is here provided that the pressing plate is subdivided into individual areas which comprise an irregular edge contour, in particular following polygonal lines. The areas of the pressing plates are here arranged directly one next to the other and accordingly have a partially identical edge contour. However, it is decisive that individual areas have a preferential direction in view of their grain or structuring extending in different directions; thus arbitrary graphic patterns can be created which can have, for example, an irregular edge contour. As an alternative, it is possible that the areas consist of simple geometric shapes, in particular of circles, triangles, polygons or rectangles, with an at least partially straight edge contour, wherein adjacent areas can also be designed so as to penetrate each other.

By the design of the pressing plates with individual areas, which at least partially comprise different grains of structure in different directions, the possibility of subjecting the material plates to corresponding embossment is created. Here, the areas of the pressing plates are adjusted to the decoration pattern such that an accurately-fitting embossment can be made.

The invention will be furthermore illustrated again with reference to four embodiments in the drawings.

### BRIEF DESCRIPTION OF THE DRAWINGS

In the drawings

FIG. 1 shows a material plate in a perspective view,

FIG. 2 shows, in a perspective exploded view, the material plate with a layer sequence and a congruent printed decor,

FIG. 3 shows a pressing plate for the manufacture of the material plate in a plan view, and

FIG. 4 shows in a plan view a pressing plate which is subdivided into individual areas.

### DETAILED DESCRIPTION OF THE PREFERRED EMBODIMENT

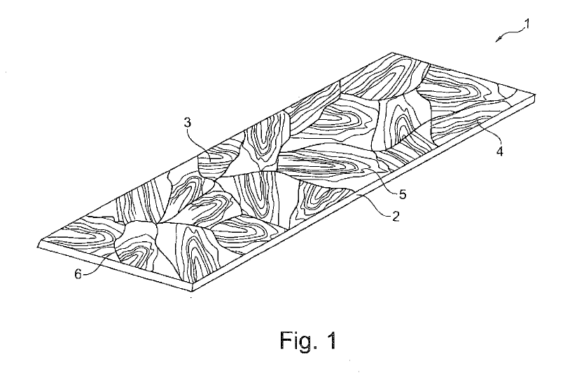

FIG. 1 shows, in a perspective view, a material plate 1 consisting of a central substrate layer 2 and at least one decorative layer 3 resting on the upper side. In the shown embodiment, the decorative layer 3 is subdivided into individual areas 4 which comprise a structuring 5. The individual areas 4 here have an irregular edge contour 6, wherein adjacent areas 4 partly have a common edge contour 6 and the structuring 5 of the individual areas 4 point into different directions, so that a graphic design with irregularly shaped areas 4 is formed. In the embodiment, a wood grain is shown, however, it is possible to arrange arbitrary structurings in this manner, for example fibre structures with a preferential direction in the respective areas 4, so that graphic patterns are formed.

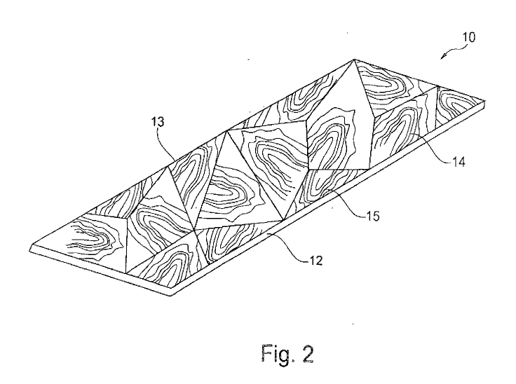

FIG. 2 shows a further embodiment of a material plate 10 in a perspective view consisting of a central substrate layer 12 and at least one decorative layer 13 resting on the upper side. Compared to the embodiment of FIG. 1, here the formed areas 14 are provided with a straight edge contour, so that here, for example, individual areas 14 in the form of a triangle, a trapezoid, a rectangle or a lozenge result. As in the first embodiment, the structuring 15 is arranged in different directions, so that in this case, too, a strictly graphic pattern is formed. A combination of the two alternative embodiments is also conceivable.

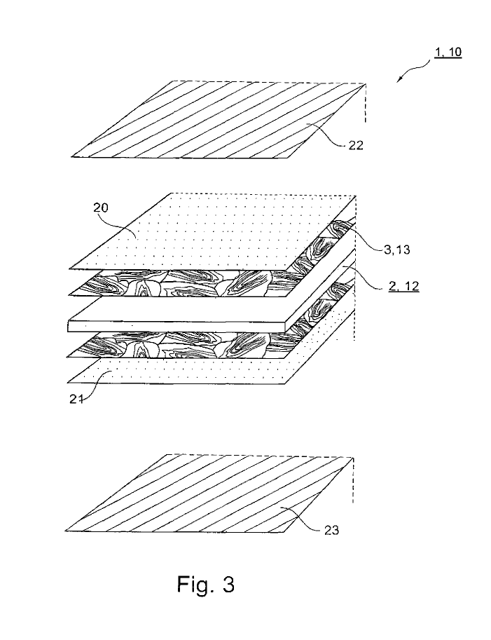

FIG. 3 shows the material plate 1, 10 according to FIGS. 1 and 2 in a perspective exploded view. One can see in this representation that the material plate 1, 10 consists of a central substrate layer 2, 12 onto which a decorative layer 3, 13, an underlay 20, 21 and an overlay 22, 23 are placed. The decorative layer 3, 13 here has a decoration with individual areas 4, 14, so that the impression of a graphic pattern is obtained after completion of the material plate 1. The decorative layer 3, 13 itself is covered by the underlay 20, 21 and the overlay 22, 23 and leads to a firm permanent bond between the overlay 22, 23 and the underlay 20, 21 and between the underlay 20, 21 and the decorative layer 3, 13 as a consequence of heating during the pressing operation. Equally, a firm connection between the decorative layer 3, 13 and the substrate layer 2, 12 is created. By the underlay 20, 21, a particularly deep embossment of the structures is permitted, while it is simultaneously ensured, with the aid of the overlay 22, 23, that the surface offers sufficient protection against cleansing agents, etc. However, it is not absolutely necessary to provide the overlays 22, 23, or optionally further overlays 3, 13, if only the decorative layer is to be used as outer layer corresponding to the customer's demands.

It is furthermore possible to vary the series of the individual layer sequence with respect to each other, for example, a layer of glue can first be placed onto the substrate layer 2, then the decorative layer 3, 13, and subsequently an overlay 22, 23. Furthermore, layers of glue could be disposed between the individual layers if these are not impregnated with amino resin themselves, ensuring bonding after heating and curing. In the present case, the type of sequence of the individual layers is not very important, but rather the fact that the decorative layer 3, 13, no matter in what position it is included in the layer sequence, has a graphic design with individual areas 4, 14.

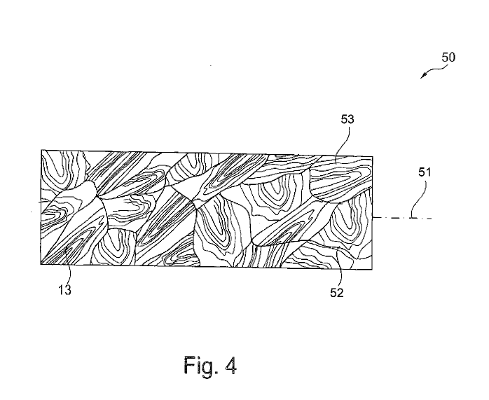

FIG. 4 shows in a plan view a pressing plate 50 which is subdivided into individual areas 51 according to the material plate 1. The individual areas 51 have an irregular edge contour 52 each with a separate structure 53 whose main preferential direction points into different directions. The shown wood grain can be replaced by comparable structures, for example fibre structures or the like, with a main preferential direction.

### LIST OF REFERENCE NUMERALS

1 Material plate
2 Substrate layer
3 Decorative layer
4 Area
5 Structuring
6 Edge contour
10 Material plate
12 Substrate layer
13 Decorative layer
14 Area
15 Structuring
20 Underlay
21 Underlay
22 Overlay
23 Overlay
50 Pressing plate
51 Area
52 Edge contour
53 Structure

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A material plate for the manufacture of furniture, floor covering or door elements, comprising at least one central substrate layer and a decorative layer on at least one side of the central substrate layer,
wherein
the decorative layer has a decorative pattern with adjacent adjoining areas and a surface structure, wherein the grain of the decorative pattern in each area runs in a different direction than the grain of the decorative pattern in adjacent adjoining areas, wherein the grain of the surface structure is positionally aligned with the grain of the decorative pattern in matching correspondence, and wherein the adjacent adjoining areas comprise irregular edge contours or polygon-shaped edge contours with a varying number of corners.

14. The material plate according to claim 13,
wherein
the irregular edge contours are curved and each has a varying curvature radius.

15. The material plate according to claim 13,
wherein
the irregular edge contours of the adjacent adjoining areas are made up of a line with a plurality of segments of the same or different lengths.

16. The material plate according to claim 15,
wherein
the segments are linear and take an abruptly different direction than the directly adjacent segment at the transition between segments.

17. The material plate according to claim 15,
wherein
the segments are curved and take an abruptly different direction than the directly adjacent segment at the transition between segments.

18. The material plate according to claim 13,
wherein
the decorative layer is present on both sides of the central substrate layer.
